(19) United States
(12) Patent Application Publication
(10) Pub. No.: US 2005/0184660 A1
(43) Pub. Date: Aug. 25, 2005

(54) Light-emitting component

(75) Inventors: Wolfgang Kern, Neuseiersberg (AT); Egbert Zojer, Graz (AT)

Correspondence Address: BIRCH STEWART KOLASCH & BIRCH, PO BOX 747, FALLS CHURCH, VA, 22040-0747, US

(73) Assignee: Austria Wirtschaftsservice Gesellschaft M.B.H., Vienna (AT)

(21) Appl. No.: 11/000,135

(22) Filed: Nov. 30, 2004

Related U.S. Application Data
(63) Continuation of application No. PCT/AT03/00156, filed on May 28, 2003.

(30) Foreign Application Priority Data
May 29, 2002 (AT) A 827/2002

(51) Int. Cl. H01J 1/62; H01J 63/04

(52) U.S. Cl. 313/506

(57) ABSTRACT

In a light-emitting component (LED), comprising a support (1), electrodes (2, 5), a light-emitting layer (4) and, optionally, one or more additional layers (3), the layer (4) contains at least two organic constituents that emit light in different colours, with one of the constituents being provided in excess, and the emission by the constituent or constituents not provided in excess is reduced or entirely suppressed in locally defined regions with regard to the rest of the layer as a result of a radiochemical process. Said component, which can be produced in a rapid and economical manner, can be advantageously used in devices that require a structured polychromatic light emission.

This application is a Continuation of co-pending PCT International Application No. PCT/AT03/00156 filed on 28 May 2003, which designated the United States, and on which priority is claimed under 35 U.S.C. § 120, the entire contents of which are hereby incorporated by reference.

The invention relates to a light-emitting component (LED), in particular an organic light-emitting component which is multicoloured or variable with respect to its emission colour, respectively, comprising a support, electrodes, a light-emitting layer and, optionally, one or more additional layers, as well as to a process for its manufacture.

It is known that light-emitting components with low electrical operating voltages, so-called “light-emitting devices” (LED), can be produced from organic materials (C. W. Tang, S. A. VanSlyke, Appl. Phys. Lett. 51, 913 (1987)). In the literature, such components are also referred to as “light-emitting diodes”. For LEDs based on organic materials, also the abbreviation OLED is used in the literature, for LEDs based on polymers, the abbreviation PLED is used as well. The design principle of such LEDs is described in detail in the above-mentioned article by C. W. Tang et al. Furthermore, organic LEDs are also described in the following articles: J. Kalinowski, J. Phys. D: Appl. Phys. 32, R179 (1999), R. H. Friend, R. W. Gymer, A. B. Holmes, J. H. Burroughes, R. N. Marks, C. Taliani, D. D. C. Bradley, D. A. Dos Santos, J. L. Bredas, M. Lögdlund, W. R. Salaneck, Nature (London) 397, 121 (1999) and H. Sixl, H. Schenk, N. Yu, Physikalische Blatter 54/3, 225 (1998).

Conjugated polymers (e.g. U.S. Pat. No. 5,247,190) and oligomers as well as low-molecular organic constituents can be used as organic materials.

In terms of the present invention, organic constituents composed of more than 20 repeat units are referred to as “polymers”. Organic constituents consisting of 6 to 20 repeat units are in the following referred to as “oligomers”.

However, for the purpose of the present invention, the term polymer (“poly-”) as used in the specification and claims always also comprises the corresponding oligomers, without that being explicitly mentioned in each case.

Organic constituents consisting of 2 to 5 repeat units are in the following counted among the “low-molecular compounds”. Numerous examples of low-molecular compounds which may be used for the assembly of LEDs are included in the synoptic article by J. Kalinowski (J. Phys. D: Appl. Phys. 32, R179 (1999)), among those, aromatic compounds such as derivatives of anthracene, perylene and stilbene, heterocyclic compounds such as derivatives of oxazole and oxadiazole as well as metal-complex compounds such as tris(8-hydroxy-quinoline)aluminium (Alq3) and porphyrin complexes.

In general, only a particular luminescent dye can be generated by means of a single light-emitting thin layer at a certain operating voltage, with the luminescent dye being determined primarily by the organic materials being used. However, a polychromatic light-emitting diode as well as a structuring of the polychromatic light emission are interesting in particular for applications in colour screens and display elements. Methods of producing such structured light-emitting diodes are known in the art.

The combination of a white light emitter with structured red, green and blue filter elements is described, for instance, by J. Kido, M. Kimura and K. Nagai (Science 267, 1332 (1995)). In U.S. Pat. No. 5,294,870, colour conversion materials are used for that purpose, which materials are based on the property that, in organic molecules, the emission, in comparison with the absorption, is shifted toward longer wavelengths. Likewise, a light-emitting diode with a multi hetero-layer structure consisting of red, green and blue emitters is known (Z. Shen, P. E. Burrows, V. Bulovic, S. R. Forrest, M. E. Thompson, Science 276, 2009 (1997); G. Parthasarathy, G. Gu, S. R. Forest, Adv. Mater. 11, 907 (1999)). A combined red, green and blue emission was also realized by locally resolved etching processes (C. C. Wu, J. C. Sturm, R. A. Register; M. E. Thompson, Appl. Phys. Lett. 69, 2959 (1996)).

In recent years, printing processes have increasingly been used which are aimed at applying various dyes in a locally resolved manner in order to thereby guarantee a structured emission (T. R. Hebner, C. C. Wu, D. Marcy, M. H. Lu, J. C. Sturm, Appl. Phys. Lett. 72, 519 (1998); S.-C. Chang, J. Bharathan, Y. Yang, R. Helgeson, F. Wudl, M. B. Ramey, R. Reynolds, Appl. Phys. Lett. 73, 2561 (1998); D. A. Pardo, G. E. Jabbour, N. Peyghambarian, Adv. Mater. 12, 1249 (2000)).

However, the hitherto known processes have the disadvantage that, thechnologically, they are highly complex, thus causing high expenditures.

S. Shirei and J. Kido (J. Photopolymer Science and Technology 14(2), 317 (2001)) describe a process for the generation of an emission resolved in pixels, wherein dye molecules dispersed in a poly(N-vinylcarbazole) matrix are bleached oxidatively. Conventional lamination processes may be used for this purpose.

A known process for the generation of emission patterns in monochromic LEDs (K. Tada, M. Onoda, Thin Solid Films 363, 195 (2000); C. Kocher, A. Montali, P. Smith, C. Weder, Adv. Funct. Mater. 11, 31 (2001)) consists in irradiating the organic light-emitting layer with ultraviolet light in a laterally resolved manner in the presence of oxygen. Components of the organic light-emitting layer are photooxidized in this manner, whereby they change their emission behaviour. The optical properties of particular organic light-emitting materials are similarly changed by irradiation with ultraviolet light in the presence of hydrazine. The photoreactions of aromatic polymers such as polystyrene and poly(vinylnaphthalene) were described by W. Kern et al. in RadTech Europe 2002, Conference Proceedings, pages 699-704, RadTech Europe Association (Den Haag) and Vincentz Verlag (Hannover), 2001.

By means of the above-mentioned process, the emission of the organic materials is quenched in a locally structured manner. However, the shift of the emission spectrum which can be achieved in this way is very small. Another disadvantage is that, due to the photochemical alteration in all irradiated zones of the active layer of the LED component, the charge transport necessary for the activity as LED is affected to an enormous extent.

The invention aims at overcoming said disadvantages and has as its object to provide a light-emitting component which can be produced in a rapid and economical manner and requires neither a multi-layered design nor elaborate printing techniques for achieving locally structured colour differences in the emission.

According to the invention, said object is achieved in that the light-emitting layer of the component contains at least two organic constituents that emit light in different colours, with one of the constituents being provided in excess, and that the emission by the constituent or constituents not provided in excess is reduced or entirely suppressed in locally defined regions with regard to the rest of the layer as a result of a radiochemical process.

The following processes play an important part in the light generation of a light-emitting layer containing at least two constituents, wherein the transport of the charge carriers is preferably conducted via the constituent provided in excess (“host”):
(i) Electrons and holes meet in the host material where they create an excited condition. Said excited condition may now recombine radiatively in the host material. The spectral distribution of the thereby emerging light is determined by the chemical constitution and morphology of the host material.
(ii) The excitation energy can be transferred from the host to the constituent(s) not provided in excess (“guest”), whereupon a radiative recombination may occur in the guest system. When using several guest systems with appropriate optical/electronic properties, an energy transfer between the individual guest materials is possible as well.
(iii) When choosing an appropriate guest material (guest materials), i.e. if the ionization energy is adequately small and the electron affinity is adequately high, it is also possible that the excited conditions will emerge to a significant extent directly on the guest molecules where they will then recombine radiatively.

In cases (ii) and (iii), the spectral distribution of the emerging light is determined by the chemical constitution and morphology of the guest material (guest materials). The overall colour effect is determined by how large the relative amounts of the emission from the host—as a result of process (i)—and from the guest (guests)—as a result of processes (ii) and (iii) —are.

Such energy transfer processes are well known to a person skilled in the art and are also used for adjusting a particular luminescent dye of a light-emitting component (S. Tasch, E. J. W. List, 0. Ekström, W. Graupner, G. Leising, P. Schlichting, U. Rohr, Y. Geerts, U. Scherf, K. Mullen, Appl. Phys. Lett. 71, 2883 (1997)).

According to the invention, the guest material (the guest materials or one of the guest materials) is changed by radiochemical processes in well defined regions of the light-emitting layer in such a way that process (ii) and/or process (iii) is/are reduced or completely prevented, whereby the relative amount of the emission from the guest or guests, respectively, decreases, resulting in a change in the overall colour effect.

However, the amount of the emission by the guest material (guest materials) can also be reduced or suppressed if processes (ii) and (iii) are not reduced or prevented, i.e., if, after the radiochemical reaction, energy transfer processes from host to guest (guests) are still feasible and a direct emergence of the excited conditions on the guest molecules is also still possible. In this case, however, the ratio between radiative and non-radiative recombination processes is altered in accordance with the invention by a radiochemical reaction.

It was surprising and not obvious to a person skilled in the art that certain radiochemical processes allow the guest constituent(s) to be selectively or preferably transformed in the guest-host systems, thereby changing the emission colour of the component. It was completely unexpected that, by means of such processes, when choosing the appropriate chemical constitution, the concentration of the guest material and when adjusting the radiochemical reaction conditions accordingly, it is possible to produce components wherein the emission of the unirradiated regions is determined by the guest molecule whereas the regions that are reacted radiochemically display essentially the emission colour of the host.

In a preferred embodiment, the light-emitting layer of the component contains, as organic constituents, conjugated polymers or conjugated oligomers selected from the group consisting of poly(paraphenylene vinylene) derivatives, poly(paraphenylene) derivatives and poly(thiophene) derivatives. A summary of conjugated polymers and the structures and properties thereof can be found in the Handbook of Conducting Polymers, Editor T. A. Skotheim, R. L. Eisenbaumer and J. R. Reynolds, Publ. Marcel Dekker Inc., Ney York 1998.

According to a particularly preferred embodiment, the light-emitting layer contains a derivative of poly(paraphenylene) as the constituent provided in excess (host material). Among other things, the derivatives of poly(paraphenylene), poly(fluorene) and the derivatives thereof as well as bridged poly(phenylenes) rank among those. Ladder type poly(paraphenylene) (LPPP) (A. Haugeneder et al., Applied Physics B 66, 389-392 (1998)) and spiro-6-paraphenylene (H. Sixl et al., Phys. B1. 54/3, 225-230, (1998)) can be named as examples of bridged poly(phenylene) types.

In said preferred embodiment, derivatives of poly(paraphenylene vinylene) are used as guest molecule(s). The phenylene vinylene derivatives are thereby transformed far more efficiently by the radiochemical reaction than the poly(paraphenylene) derivatives. As a result, the conjugation in the phenylene vinylene derivatives is reduced, leading to a significant widening of the energy gap. In consequence of said effect, processes (ii) and (iii) are suppressed.

In another preferred embodiment, the constituent provided in excess is a derivative of poly(paraphenylene) and the further organic constituent or the further organic constituents are conjugated polymers or conjugated oligomers containing vinylene units in the main chain.

A further preferred embodiment is characterized in that the organic constituent provided in excess is a derivative of poly(paraphenylene) and the further organic constituent or the further organic constituents are low-molecular compounds such as dyes or oligomers.

Preferably, the derivative of poly(paraphenylene) is a poly(fluorene) derivative or a bridged poly(paraphenylene) derivative.

In a further preferred embodiment, the organic constituents are low-molecular compounds such as aromatic compounds such as derivatives of anthracene, perylene and stilbene, heterocyclic compounds such as derivatives of oxazole and oxadiazole as well as metal-complex compounds such as tris(8-hydroxyquinoline)aluminium (Alq3) and porphyrin complexes. A summary of the low-molecular organic constituents that are usually used in organic light-emitting components is given in the above-mentioned article by J. Kalinowski (J. Phys. D: Appl. Phys. 32, R179 (1999)). In the application according to the invention of low-molecular organic constituents, analogous principles for the radiochemical structuring of the emission colour are applied.

The process for the manufacture of the light-emitting components according to the invention, wherein a first electrode, a light-emitting layer and a second electrode as well as, optionally, one or more additional intermediate layers are applied on top of each other on a support, is characterized in that, prior to the application of the second electrode, the light-emitting layer is irradiated and reacted radiochemically in locally defined regions in the presence of a reagent.

Preferably, the radiochemical reaction is performed in the presence of a gaseous reagent. hi a particularly preferred embodiment, hydrazine or a hydrazine derivative is used as a gaseous reagent. Thereby, the light-emitting layer is irradiated, for instance, with ultraviolet light in a wavelength range of between 180 nm and 280 nm. Under the action of light, such reagents lead to a preferred reductive reaction of the above-mentioned guest molecules.

In a further particularly preferred embodiment, a gaseous thiol, i.e. a compound containing the mercapto group —SH such as 2-propanethiol, for instance, is used as a gaseous reagent. Thereby, the light-emitting layer is irradiated, for instance, with ultraviolet light in a wavelength range of between 180 nm and 280 nm in the presence of a thiol. Under the action of light, such thiols lead to a preferred reaction of the above-mentioned guest molecules via the so-called thiol-en photoreaction. Said thiol-en reaction represents a reaction of the C═C double bonds with thio molecules, with thioether units being formed, and can be accelerated by the presence of radical initiators such as aromatic-aliphatic ketones, for instance.

As a matter of course, thiols which exhibit low vapour pressure and were admixed to the light-emitting layer prior to the beginning of the light exposure can also be used for said reaction in accordance with the present invention. The so-called thiol-en photoreaction as well as the possibilities of catalytically accelerating said reaction are described, for instance, by A. Jacobine in the monography “Radiation Curing in Polymer Science”, Vol. III, Elsevier (London 1993), p. 219-268.

The reaction in the presence of a gaseous reagent can be performed such that the guest-host system, i.e. the light-emitting layer, is applied onto a substrate in the form of a film and the gaseous reagent is allowed to flow across the surface of the film during irradiation. However, such a film may also be irradiated in a static gas atmosphere. Preferably, the reagent is introduced into the material to be reacted by means of a diffusion process prior to the beginning of irradiation.

The irradiation can be carried out either in a planar or in a laterally structured manner, for example, in accordance with the methods of projection lithography.

Other preferred embodiments comprise radiochemical processes in the presence of other reducing reagents, in the presence of oxygen or other oxidizing agents or in the presence of reagents which initiate the desired chemical reactions in the guest molecules by means of addition or substitution reactions.

According to a further preferred embodiment, the reagent to be reacted radiochemically is introduced into the guest-host system already during the manufacture of the light-emitting layer.

In a particularly preferred embodiment, a liquid alkanethiol such as dodecanethiol, which is admixed to the solution used for producing the polymer layer, is used as the reagent to be reacted radiochemically.

The irradiation is preferably performed by means of ultraviolet light. However, gamma rays, X-rays and corpuscular radiation such as electron or ion beams may also be used, depending on the composition of the light-emitting layer and of the reagent being used.

In another preferred embodiment, different locally defined regions of the light-emitting layer are irradiated for different amounts of time. Due to different durations of the radiochemical reactions, for instance, by varying the time of the exposure to ultraviolet light, guest-host systems can be altered such that a wide palette of emission colours (mixed colours) can be achieved.

In order to achieve several emission colours, also several different guest molecules can be contained in the light-emitting layer, whose emission properties—according to the type and degree of the radiochemical reaction—are changed in different ways in a locally resolved manner.

A further variation is achieved, for example, in that guest molecules of a similar chemical reactivity but with different emission colours are contained in the guest-host system in different concentrations. By choosing the appropriate individual concentrations of guest molecules, it is possible to largely suppress the light emission by the guest molecule provided at a lower concentration—with the radiochemical process being realized adequately—while the emission by the guest constituent provided at a higher concentration still contributes significantly to the colour effect of the LED element.

In a further embodiment, the individual guest constituents differ from each other also in terms of their reaction velocity for the reaction during the radiochemical process. Also in this case, the colour effect of the emission by the component can be altered within certain limits by varying the duration of the radiochemical process.

By means of the above-mentioned embodiments of the present invention, multicoloured display elements (LED) as well as display elements with mixed colours are feasible. With the above-described embodiments it is possible in particular to selectively change the emission colour determined by an appropriate assembly of the organic constituents of the component by means of the radiochemical process and to adapt the same for the particular intended use.

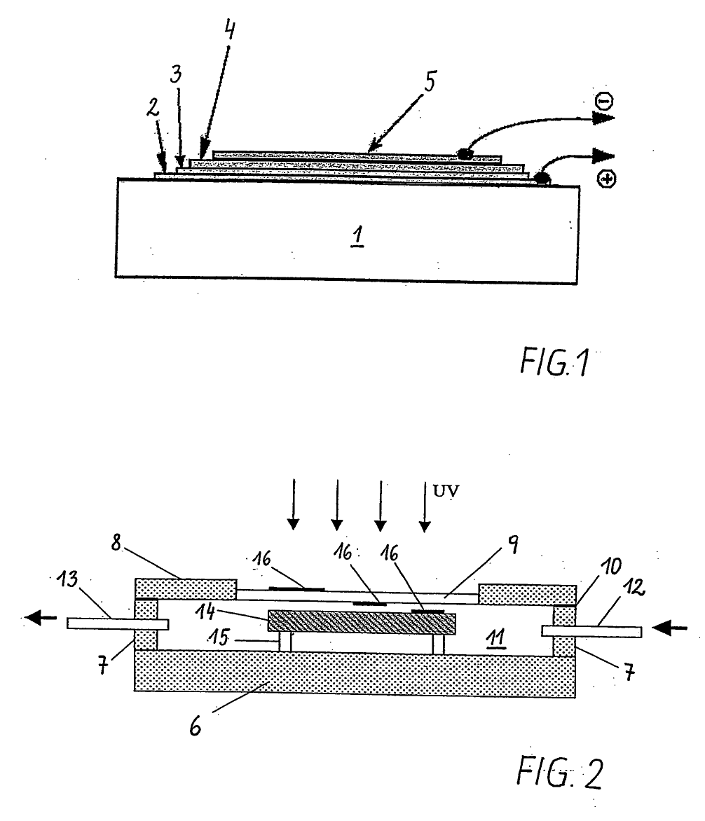

FIG. 1 shows the schematic design of an organic light-emitting component which is operable by a direct electrical voltage. An indium/tin oxide (ITO) electrode 2 is applied to a support 1, for instance a glass substrate, which electrode forms the anode for the external voltage supply. A poly(dioxyethylene thienylene) (PEDOT) layer 3, which optionally may be doped with poly(styrene sulfonic acid) (PSS), is located above the electrode layer 2. The PEDOT layer 3 is optional and may also be omitted in the design. The next step of the design is a light-emitting polymer layer 4, to which an electrode 5 of calcium and aluminium is applied, which functions as a cathode for the external voltage supply. In such light-emitting components, additional layers may optionally be applied on top of each other, for instance charge transport layers or layers which cause a directional reflection of light. Below, the invention is illustrated further by way of examples.

### EXAMPLE 1

Poly(fluorene) (poly(9,9-di-(2-ethylhexyl)-fluorenyl-2,7-diyl), synthesized according to H. G. Nothofer, dissertation at the University of Potsdam 2001, Logos Verlag, Berlin 2001, ISBN 3-89722-668-5, and MEH-PPV [poly(2-methoxy-5-(2-ethylhexyloxy)-1,4-phenylene vinylene)], synthesized according to H.-H. Hörhold, H. Tillmann, C. Bader, R. Stockmann, J. Nowotny, E. Klemm, W. Holzer, A. Penzkofer, Synth. Met. 119, 199 (2001), were dried for 3 hours in a high vacuum (10⁻⁵ mbar) at 70° C. Solutions in toluene were produced from the dried polymers under an argon atmosphere. The concentration of polyfluorene amounted to 10 g per litre of toluene, the concentration of MEH-PPV amounted to 1 g per litre of toluene.

A mixture was prepared from those two solutions so that polyfluorene and MEH-PPV were contained at a weight ratio of 99.5:0.5. The total polymer concentration was 9.6 g per litre of toluene. According to the above-described invention, the polyfluorene acts thereby as the constituent provided in excess (host material) and MEH-PPV acts as the constituent not provided in excess (guest material).

A glass substrate (1.5 cm×1.5 cm), provided on its surface with an indium tin oxide (ITO)—strip having a width of 9 mm, was etched in oxygen plasma. For plasma etching, the procedure described by J. S. Kim et al. (Journal of Applied Physics 84, 6860 (1998)) was followed. Subsequently, a layer of poly(dioxyethylene thienylene) (PEDOT), doped with poly(styrene sulfonic acid) (PSS), was applied by spin coating at a layer thickness of <100 nm under an air atmosphere, using a commercially available lacquer centrifuge. The PEDOT doped with PSS was purchased from Bayer A G (Germany) under the trade name Baytron P. Upon drying (120° C. , 20 min, under an argon atmosphere) and subsequent vacuum drying (120° C., 3 hours, 10⁻⁵ mbar), a thin film of the previously described polymer mixture (containing polyfluorene and MEH-PPV) was applied onto said layer by spin coating under an argon atmosphere. Thereupon, the sample was dried for 3 hours at 70° C. in an argon atmosphere (at a pressure of 1 bar).

The sample was introduced into a steel container manufactured from corrosion-resistant steel, which container enabled the sample to be exposed to ultraviolet light through a quartz window. The basic design of the steel container is illustrated (in cross-section) in FIG. 2.

The steel container is composed of a base 6, which can optionally be thermostated, side windows 7 as well as a screwable lid 8 with a quartz window 9 embedded therein and a circumferential sealing 10. In the sample space 11 which is flushed with gas via an inlet nozzle 12 and an outlet nozzle 13, the sample 14 to be irradiated is positioned by means of a mounting device 15 such that it can be irradiated through the quartz window 9. Planar or shadow masks 16 to be used optionally can be mounted suitably, for example, at the indicated positions.

At first, the steel container was flushed with pure nitrogen for about 15 min in order to displace the atmospheric air provided in the steel container. Thereupon, gaseous nitrogen was passed through a glass vessel thermostated to 70° C., wherein anhydrous hydrazine was provided. The anhydrous hydrazine had previously been prepared from commercially available hydrazine hydrate according to the instructions of H. Bock and G. Rudolph (Z. Anorg. Allg. Chem. 311, 117 (1962)). The nitrogen stream charged with hydrazine in such a manner was passed for 15 min through the steel container which previously had been flushed with pure nitrogen. Finally, the sample now lying in the steel container under a nitrogen/hydrazine atmosphere was exposed to polychromatic light with an unfiltered mercury high-pressure lamp (Heraeus Q1023) for 20 sec at a temperature of 25° C. The distance between the lamp and the sample surface was 12 cm. The exposure to ultraviolet light was performed such that a portion of the sample surface was covered by a planar mask. During the light exposure, flushing was continued with the nitrogen/hydrazine mixture. Upon completion of the light exposure, the steel container was flushed with pure nitrogen for another 15 min. Thereupon, the sample was removed from the steel container and was dried for 5 hours in a high vacuum (10⁻⁵ mbar) at 70° C.

In a high-vacuum vaporization plant (Balzers MED010), at first a planar calcium-containing thin layer was coated by evaporation onto the top side of the sample from a source containing metallic calcium at a base pressure of 3×10⁻⁶ mbar. In a further step, aluminium was planarly coated by evaporation onto the calcium-containing thin layer. The contact surface coated by evaporation was contacted with conductive silver such that no conductive connection to the ITO layer occurred. Furthermore, the ITO strip was mechanically exposed at both ends of the sample and was also contacted with conductive silver. The contacted sample was then introduced into an argon atmosphere in order to prevent access of aerial oxygen and moisture.

When a direct electrical voltage above the so-called onset voltage was applied to the individual terminals, the sample part that was previously exposed to ultraviolet light glowed light blue, whereas the unexposed part of the sample glowed in a yellow-orange colour.

Thereby, the ITO layer was polarized as an anode, and the calcium/aluminium electrode was polarized as a cathode.

By onset voltage, the direct electrical voltage is meant above which a light emission is detectable using a suitable commercially available photodiode.

### EXAMPLE 2

Poly(fluorene) (poly(9,9-di-(2-ethylhexyl)-fluorenyl-2,7-diyl), synthesized according to H. G. Nothofer, dissertation at the University of Potsdam 2001, Logos Verlag, Berlin 2001, ISBN 3-89722-668-5, and MEH-PPV [poly(2-methoxy-5-(2-ethylhexyloxy)-1,4-phenylene vinylene)], synthesized according to H.-H. Hörhold, H. Tillmann, C. Bader, R. Stockmann, J. Nowotny, E. Klemm, W. Holzer, A. Penzkofer, Synth. Met. 119, 199 (2001), were dried for 3 hours in a high vacuum (10⁻⁵ mbar) at 70° C. Solutions in toluene were produced from the dried polymers under an argon atmosphere. The concentration of polyfluorene amounted to 10 g per litre of toluene, the concentration of MEH-PPV amounted to 1 g per litre of toluene.

A mixture was prepared from those two solutions so that polyfluorene and MEH-PPV were contained at a weight ratio of 99.5:0.5. The total polymer concentration was 9.6 g per litre of toluene. According to the above-described invention, the polyfluorene acts thereby as the constituent provided in excess (host material) and MEH-PPV acts as the constituent not provided in excess (guest material).

A glass substrate (1.5 cm×1.5 cm), provided on its surface with an indium tin oxide (ITO)—strip having a width of 9 mm, was etched in oxygen plasma. For plasma etching, the procedure described by J. S. Kim et al. (Journal of Applied Physics 84, 6860 (1998)) was followed. Subsequently, a layer of poly(dioxyethylene thienylene) (PEDOT), doped with poly(styrene sulfonic acid) (PSS), was applied by spin coating at a layer thickness of <100 nm under an air atmosphere, using a commercially available lacquer centrifuge. The PEDOT doped with PSS was purchased from Bayer A G (Germany) under the trade name Baytron P. Upon drying (120° C., 20 min, under an argon atmosphere) and subsequent vacuum drying (120° C., 3 hours, 10⁻⁵ mbar), a thin film of the previously described polymer mixture (containing polyfluorene and MEH-PPV) was applied onto said layer by spin coating under an argon atmosphere. Thereupon, the sample was dried for 3 hours at 70° C. in an argon atmosphere (at a pressure of 1 bar).

The sample was introduced into a steel container manufactured from corrosion-resistant steel, which container enabled the sample to be exposed to ultraviolet light through a quartz window (see FIG. 2). At first, the steel container was flushed with pure nitrogen for about 15 min in order to displace the atmospheric air provided in the steel container. Thereupon, gaseous nitrogen was passed through a glass vessel thermostated to 70° C., wherein anhydrous hydrazine was provided. The anhydrous hydrazine had previously been prepared from commercially available hydrazine hydrate according to the instructions of H. Bock and G. Rudolph (Z. Anorg. Allg. Chem. 311, 117 (1962)). The nitrogen stream charged with hydrazine in such a manner was passed for 15 min through the steel container which previously had been flushed with pure nitrogen. Finally, the sample now lying in the steel container under a nitrogen/hydrazine atmosphere was exposed to polychromatic light with an unfiltered mercury high-pressure lamp (Heraeus Q1023) for 20 sec at a temperature of 25° C. The distance between the lamp and the sample surface was 12 cm, the temperature of the sample was about 25° C.

With the aid of planar masks, the exposure to ultraviolet light was conducted such that one region of the sample surface was exposed for 5 sec, a further region was exposed for 20 sec, and another region was exposed to ultraviolet light for 40 sec. Another region of the sample surface was covered by a screen and remained completely unexposed. During the exposure to ultraviolet light, flushing was continued with the nitrogen/hydrazine mixture. Upon completion of the light exposure, the steel container was flushed with pure nitrogen for another 15 min. Thereupon, the sample was removed from the steel container and was dried for 5 hours in a high vacuum (10⁻⁵ mbar) at 70° C.

In a high-vacuum vaporization plant (Balzers MED010), at first a planar calcium-containing thin layer was coated by evaporation onto the top side of the sample from a source containing metallic calcium at a base pressure of 3×10⁻⁶ mbar. In a further step, aluminium was coated by evaporation onto the calcium-containing thin layer.

In doing so, the evaporation was conducted through shadow masks which were structured such that several contact surfaces which were separate from each other and had a size of about 7 mm×5 mm were generated on the sample surface. The positions of the contact surfaces were chosen such that a separate contact surface was provided for each of the sample regions that were exposed to ultraviolet light for different amounts of time.

The contact surfaces coated by evaporation were contacted with conductive silver such that no conductive connection to the ITO layer occurred. Furthermore, the ITO strip was mechanically exposed at both ends of the sample and was also contacted with conductive silver. The contacted sample was then introduced into an argon atmosphere in order to prevent access of aerial oxygen and moisture.

When a direct electrical voltage above the so-called onset voltage was applied to the individual contact surfaces, the region that was not exposed to ultraviolet light emitted a yellow-orange light, the region that was exposed for 5 sec emitted a yellow-green light, the region that was exposed for 20 sec emitted a pale blue light, and the region that was exposed for 40 sec emitted a blue light.

### EXAMPLE 3

The following materials used for this example were purchased from American Dye Source, Inc., Quebec, Canada:
ADSBE129[poly(9,9-di-n-octylfluorenyl-2,7′-diyl)], ADSGE108[poly{(9,9-dioctyl-2,7-divinylene fluorenylene)-alt-co-(2-methoxy-5-(2-ethylhexyloxy)-1,4-phenylene) }] and ADSRE111[poly{(9,9-dihexyl-2,7-bis(1-cyanovinylene)fluorenylene)-alt-co-(2,5-bis(N,N-diphenylamino)-1,4-phenylene)}].

The polymers were dried for 3 hours in a high vacuum (10⁻⁵ mbar) at 70° C. Solutions in toluene were produced from the dried polymers under an argon atmosphere. The concentration of ADSBE129 amounted to 10 g per litre of toluene, the concentration of ADSGE108 amounted to 5 g per litre of toluene, and the concentration of ADSRE111 amounted to 4 g per litre of toluene.

A mixture was prepared from those solutions so that ADSBE129 to ADSGE108 to ADSRE111 was contained at a weight ratio of 80 to 15 to 5. After an additional dilution with toluene, the total polymer concentration was 7 g per litre of toluene. Said mixture was heated to 70° C. for one hour and was at the same time stirred with a stirring magnet coated with poly(tetrafluoroethylene) and with a magnetic stirrer at 150 revolutions per minute. According to the above-described invention, ADSBE129 acts thereby as the host material and ADSGE108 and ADSRE111 act as the guest materials.

A glass substrate (1.5 cm×1.5 cm), provided on its surface with an indium tin oxide (ITO)-strip having a width of 9 mm, was etched in oxygen plasma. For plasma etching, the procedure described by J. S. Kim et al. (Journal of Applied Physics 84, 6860 (1998)) was followed. Subsequently, a layer of poly(dioxyethylene thienylene) (PEDOT), doped with poly(styrene sulfonic acid) (PSS), was applied by spin coating at a layer thickness of <100 nm under an air atmosphere, using a commercially available lacquer centrifuge. The PEDOT doped with PSS was purchased from Bayer A G (Germany) under the trade name Baytron P. Upon drying (120° C., 20 min, under an argon atmosphere) and subsequent vacuum drying (120° C., 3 hours, 10⁻⁵ mbar) a thin film of the previously described polymer mixture (containing ADSBE120, ADSGE108 and ADSRE111) was applied onto said layer by spin coating under an argon atmosphere. Thereupon, the sample was dried for 3 hours at 70° C. under an argon atmosphere (at a pressure of 1 bar).

The sample was introduced into a steel container manufactured from corrosion-resistant steel, which container enabled the sample to be exposed to ultraviolet light through a quartz window (see FIG. 2). At first, the steel container was flushed with pure nitrogen for 15 min in order to displace the atmospheric air provided in the steel container. Thereupon, gaseous nitrogen was passed through a glass vessel thermostated to 70° C., wherein anhydrous hydrazine was provided. The anhydrous hydrazine had previously been prepared from commercially available hydrazine hydrate according to the instructions of H. Bock und G. Rudolph (Z. Anorg. Allg. Chem. 311, 117 (1962)).

Finally, the sample lying in the steel container under a nitrogen/hydrazine atmosphere was exposed to light with an unfiltered mercury high-pressure lamp (Heraeus Q1023). In doing so, individual regions of the surface were exposed for 20 seconds, individual regions were exposed for 90 seconds through planar masks. The remaining part of the sample was not exposed. The distance between the lamp and the sample surface was 12 cm. During the light exposure, flushing was continued with the nitrogen/hydrazine mixture. The temperature in the steel chamber was 25° C.

Upon completion of the light exposure, the steel container was flushed with pure nitrogen for another 15 min. Thereupon, the sample was removed from the steel container and was dried for 5 hours in a high vacuum at 10⁻⁵ mbar at 70° C.

In a high-vacuum vaporization plant (Balzers MED010), at first a planar calcium-containing thin layer was coated by evaporation onto the top side of the sample from a source containing metallic calcium at a base pressure of 3×10⁻⁶ mbar. In a further step, aluminium was planarly coated by evaporation onto the calcium-containing thin layer.

In doing so, the evaporation was conducted through shadow masks which were structured such that several contact surfaces which were separate from each other and had a size of about 7 mm×5 mm were generated on the sample surface. The positions of the contact surfaces were chosen such that a separate contact surface was provided for each of the sample regions that were exposed to ultraviolet light for different amounts of time.

The contact surfaces coated by evaporation were contacted with conductive silver such that no conductive connection to the ITO layer occurred. Furthermore, the ITO strip was mechanically exposed at both ends of the sample and was also contacted with conductive silver. The contacted sample was then introduced into an argon atmosphere in order to prevent access of aerial oxygen and moisture.

When a direct electrical voltage (above the so-called onset voltage) was applied to the individual contact surfaces, the sample part that was exposed to light for 20 sec glowed turquoise, the sample part that was exposed for 90 sec glowed blue, and the unexposed sample part glowed orange-red.

### EXAMPLE 4

For this example, the following chemical was purchased from American Dye Source, Inc., Quebec, Canada: ADSBE129[poly(9,9-di-n-octylfluorenyl-2,7′-diyl)], likewise, the following component was purchased from Sigma-Aldrich: MEHPPV[poly(2-methoxy-5-(2-ethylhexyloxy)-1,4-phenylene vinylene)]

The polymers were dried for 3 hours in a high vacuum (10⁻⁵ mbar) at 70° C. Solutions in chloroform were produced from the dried polymers under an argon atmosphere. The concentration of ADSBE129 amounted to 5 g per litre of chloroform, the concentration of MEHPPV amounted to 5 g per litre of chloroform.

A mixture was prepared from those solutions so that ADSBE129 to MEHPPV was contained at a weight ratio of 99 to 1. Said mixture was stirred for at least one hour with a stirring magnet coated with poly(tetrafluoroethylene) and with a magnetic stirrer at 150 revolutions per minute. According to the above-described invention, ADSBE129 acts thereby as the host material and MEHPPV acts as the guest material.

A glass substrate (1.5 cm×1.5 cm), provided on its surface with an indium tin oxide (ITO)-strip having a width of 9 mm, was etched in oxygen plasma. For plasma etching, the procedure described by J. S. Kim et al. (Journal of Applied Physics 84, 6860 (1998)) was followed. Subsequently, a layer of poly(dioxyethylene thienylene) (PEDOT), doped with poly(styrene sulfonic acid) (PSS), was applied by spin coating at a layer thickness of <100 nm under an air atmosphere, using a commercially available lacquer centrifuge. The PEDOT doped with PSS was purchased from Bayer A G (Germany) under the trade name Baytron P. Upon drying (120° C., 20 min, under an argon atmosphere) and subsequent vacuum drying (120° C., 3 hours, 10⁻⁵ mbar), a thin film of the previously described polymer mixture (containing ADSBE129 and MEHPPV) was applied onto said layer by spin coating under an argon atmosphere. Thereupon, the sample was dried for 3 hours at 70° C. under an argon atmosphere (at a pressure of 1 bar).

The sample was introduced into a steel container manufactured from corrosion-resistant steel, which container enabled the sample to be exposed to ultraviolet light through a quartz window (see FIG. 2). At first, the steel container was flushed with pure nitrogen for 15 min in order to displace the atmospheric air provided in the steel container. Thereupon, a nitrogen stream was first passed through a glass vessel containing liquid 2-propanethiol and subsequently through the previously described steel container in order to expose the sample lying in the steel container to an atmosphere containing nitrogen and gaseous 2-propanethiol.

Finally, the sample lying in the steel container under this atmosphere (containing nitrogen and gaseous 2-propanethiol) was exposed to light with an unfiltered mercury high-pressure lamp (Heraeus Q1023, 1300 W). In doing so, individual regions of the surface were exposed to light through planar masks for 20 seconds. The remaining part of the sample was not exposed. The distance between the lamp and the sample surface was 12 cm. During the light exposure, flushing was continued with the nitrogen12-propanethiol mixture. The temperature in the steel chamber was 25° C.

Upon completion of the light exposure, the steel container was flushed with pure nitrogen for another 15 min. Thereupon, the sample was removed from the steel container and was dried for 5 hours in a high vacuum at 10⁻⁵ mbar at 70° C.

In a high-vacuum vaporization plant (Balzers MED010), at first a planar calcium-containing thin layer was coated by evaporation onto the top side of the sample from a source containing metallic calcium at a base pressure of 3×10⁻⁶ mbar. In a further step, aluminium was planarly coated by evaporation onto the calcium-containing thin layer.

In doing so, the evaporation was conducted through shadow masks which were structured such that several contact surfaces which were separate from each other and, in overlap with the ITO layer, had a size of about 2.5 mm×2.5 mm were generated on the sample surface. The positions of the contact surfaces were chosen such that at least one contact surface was provided for each of the sample regions that were exposed to ultraviolet light for different amounts of time.

The contact surfaces coated by evaporation were contacted with conductive silver such that no conductive connection to the ITO layer occurred. Furthermore, the ITO strip was mechanically exposed at both ends of the sample and was also contacted with conductive silver. The contacted sample was then introduced into an argon atmosphere in order to prevent access of aerial oxygen and moisture.

When a direct electrical voltage (above the so-called onset voltage) was applied to the individual contact surfaces, the sample part that was exposed to light for 20 sec glowed blue, the unexposed part glowed orange.

### EXAMPLE 5

For this example, the following chemical was purchased from American Dye Source, Inc., Quebec, Canada: ADSBE129[poly(9,9-di-n-octylfluorenyl-2,7′-diyl)], likewise, the following component was purchased from Sigma-Aldrich: MEHPPV[poly(2-methoxy-5-(2-ethylhexyloxy)-1,4-phenylene vinylene)]

The polymers were dried for 3 hours in a high vacuum (10⁻⁵ mbar) at 70° C. Solutions in chloroform were produced from the dried polymers under an argon atmosphere. The concentration of ADSBE129 amounted to 5 g per litre of chloroform, the concentration of MEHPPV amounted to 5 g per litre of chloroform.

A mixture was prepared from those solutions so that ADSBE129 to MEHPPV was contained at a weight ratio of 99 to 1. Said mixture was stirred for at least one hour with a stirring magnet coated with poly(tetrafluoroethylene) and with a magnetic stirrer at 150 revolutions per minute. According to the above-described invention, ADSBE129 acts thereby as the host material and MEHPPV acts as the guest material. Dodecanethiol was added to the solution containing the polymers in such an amount that four moles of dodecanethiol were contained in said solution per mole of vinylene units of MEHPPV (molar ratio C═C to —SH equals 1 to 4).

A glass substrate (1.5 cm×1.5 cm), provided on its surface with an indium tin oxide (ITO)-strip having a width of 9 mm, was etched in oxygen plasma. For plasma etching, the procedure described by J. S. Kim et al. (Journal of Applied Physics 84, 6860 (1998)) was followed. Subsequently, a layer of poly(dioxyethylene thienylene) (PEDOT), doped with poly(styrene sulfonic acid) (PSS), was applied by spin coating at a layer thickness of <100 nm under an air atmosphere, using a commercially available lacquer centrifuge. The PEDOT doped with PSS was purchased from Bayer A G (Germany) under the trade name Baytron P. Upon drying (120° C., 20 min, under an argon atmosphere) and subsequent vacuum drying (120° C., 3 hours, 10⁻⁵ mbar), a thin film of the previously described polymer mixture (containing ADSBE129, MEHPPV and dodecanethiol) was applied onto said layer by spin coating under an argon atmosphere.

The sample was introduced into a steel container manufactured from corrosion-resistant steel, which container enabled the sample to be exposed to ultraviolet light through a quartz window (see FIG. 2). At first, the steel container was flushed with pure nitrogen for 15 min in order to displace the atmospheric air provided in the steel container. During spin coating as well as during nitrogen flushing, care was taken so as not to substantially change the ratio between MEHPPV and dodecanethiol which had been set in the combined mixture of ADSBE129, MEHPPV and dodecanethiol.

Finally, the sample lying in the steel container under a nitrogen atmosphere was exposed to light with an unfiltered mercury high-pressure lamp (Heraeus Q1023, 1300 W). In doing so, individual regions of the surface were exposed to light through planar masks for 60 seconds. The remaining part of the sample was not exposed. The distance between the lamp and the sample surface was 12 cm. During the light exposure, flushing was continued with nitrogen. The temperature in the steel chamber was 25° C.

Upon completion of the light exposure, the steel container was flushed with pure nitrogen for another 15 min. Thereupon, the sample was removed from the steel container and was dried for 5 hours in a high vacuum at 10⁻⁵ mbar at 70° C.

In a high-vacuum vaporization plant (Balzers MED010), at first a planar calcium-containing thin layer was coated by evaporation onto the top side of the sample from a source containing metallic calcium at a base pressure of 3×10⁻⁶ mbar. In a further step, aluminium was planarly coated by evaporation onto the calcium-containing thin layer.

In doing so, the evaporation was conducted through shadow masks which were structured such that several contact surfaces which were separate from each other and, in overlap with the ITO layer, had a size of about 2.5 mm×2.5 mm were generated on the sample surface. The positions of the contact surfaces were chosen such that at least one contact surface was provided for each of the sample regions that were exposed to ultraviolet light for different amounts of time.

The contact surfaces coated by evaporation were contacted with conductive silver such that no conductive connection to the ITO layer occurred. Furthermore, the ITO strip was mechanically exposed at both ends of the sample and was also contacted with conductive silver. The contacted sample was then introduced into an argon atmosphere in order to prevent access of aerial oxygen and moisture.

When a direct electrical voltage (above the so-called onset voltage) was applied to the individual contact surfaces, the sample part that was exposed to light for 60 sec glowed blue, the unexposed part glowed orange.

1. A light-emitting component (LED), comprising a support, electrodes, a light-emitting layer and, optionally, one or more additional layers, characterized in that the light-emitting layer contains at least two organic constituents that emit light in different colors and are made up of conjugated polymers or conjugated oligomers selected from the group consisting of poly(paraphenylene vinylene) derivatives, poly(paraphenylene) derivatives and poly(thiophene) derivatives, with one of the constitutes not provided in excess (host), and that the emission by the constituent or constituents not provided in excess (guest) is reduced or entirely suppressed in locally defined regions with regard to the rest of the layer as a result of a radiochemical reduction, addition or substitution.

2. A light-emitting component (LED) according to claim 1, characterized in that the organic constituent provided in excess is a derivative of poly(paraphenylene) and the further organic constituent or the further organic constituents are derivatives of poly(paraphenylene vinylene).

3. A light-emitting component (LED) according to claim 1, characterized in that the organic constituent provided in excess is a derivative of poly(paraphenylene) and the further organic constituent or the further organic constituents are conjugated polymers or conjugated oligomers containing vinylene units in the main chain.

4. A light-emitting component (LED) according to any of claims 1 to 3, characterized in that the derivative of poly(paraphenylene) is a poly(fluorine) derivative or a bridged poly(paraphenylene) derivative.

5. A process for the manufacture of a light-emitting component (LED) according to claim 1, wherein a first electrode, a light-emitting layer and a second electrode as well as, optionally, one or more additional intermediate layers are applied on top of each other on a support, characterized in that, prior to the application of the second electrode, the light-emitting layer is irradiated and reacted radiochemically in locally defined regions in the presence of a reducing reagent or an addition or substitution reagent.

6. A process according to claim 5, characterized in that irradiation and reaction are preformed in the presence of a gaseous reagent.

7. A process according to claim 6, characterized in that the gaseous reagent is hydrazine or a hydrazine derivative.

8. A process according to claim 6, characterized in that the gaseous reagent is a thiol.

9. A process according to claim 5, characterized in that the reagent is introduced into the light-emitting layer by means of a diffusion process prior to the beginning of irradiation or during the manufacture of the light-emitting layer.

10. A process according to claim 9, characterized in that a liquid alkanethiol is used as a reagent.

11. A process according to any one of claims 5 to 10, characterized in that the irradiation is performed with ultraviolet light.

12. A process according to any one of claims 5 to 10, characterized in that different locally defined regions of the light-emitting layer are irradiated for different amounts of time.

13. A process according to claim 10, wherein the liquid alkanethiol is dodecanethiol.

14. A process according to claim 8, wherein said thiol is 2-propanethiol.
